(19) United States
(12) Patent Application Publication
(10) Pub. No.: US 2024/0272794 A1
(43) Pub. Date: Aug. 15, 2024

(54) DATA PADDING REDUCTION IN LOG COPY

(71) Applicant: Western Digital Technologies, Inc., San Jose, CA (US)

(72) Inventors: Eran MOSHE, Kfar Saba, IL (US); Jonathan JOURNO, Shaarey tikwa (IL); Adi Dachlika KOPLOVICH, Yokneam Illit (IL)

(73) Assignee: Western Digital Technologies, Inc., San Jose, CA (US)

(21) Appl. No.: 18/359,151

(22) Filed: Jul. 26, 2023

Related U.S. Application Data
(60) Provisional application No. 63/485,133, filed on Feb. 15, 2023.

(51) Int. Cl. G06F 3/06

(52) U.S. Cl. CPC G06F 3/0608; G06F 3/0656; G06F 3/0673

(57) ABSTRACT

The present disclosure generally relates to improved methods for reducing static random-access memory (SRAM) padding memory consumption. Rather than a data pointer pointing to the padding in the SRAM, the data pointer points to a zero buffer. Opposed to using the padding located in the SRAM for log storage, a zero buffer will be used. A zero buffer or another storage location that is not the padding can be used for log storage to reduce the use of the SRAM. The data pointers will point the log copy to the new storage location. The use of the new location will result in more storage space in the SRAM.

### CROSS-REFERENCE TO RELATED APPLICATIONS

This application claims benefit of U.S. provisional patent application Ser. No. 63/485,133, filed Feb. 15, 2023, which is herein incorporated by reference.

### BACKGROUND OF THE DISCLOSURE

### Field of the Disclosure

Embodiments of the present disclosure generally relate to improved methods for reducing static random-access memory (SRAM) padding memory consumption.

### Description of the Related Art

A log copy is a memory buffer which holds control data for a storage device's internal modules. The internal modules are stored to the flash and allows recovery of data from ungraceful shutdown (UGSD)/graceful shutdown (GSD) by reading the last log copy.

During boot time, the storage device will search for the most updated log write. A log write is done to sync the flash with the mappings and other important storage device internal information. The log copy size should be aligned to the die page (64K) with padding. More padding is added to prevent word line to word line shorts and issues between several copies. The problem is the padding log copy consumes a lot of SRAM memory, which is a limited resource.

Therefore, there is a need in the art for an improved method to reduce the SRAM padding memory consumption.

### SUMMARY OF THE DISCLOSURE

The present disclosure generally relates to improved methods for reducing static random-access memory (SRAM) padding memory consumption. Rather than a data pointer pointing to the padding in the SRAM, the data pointer points to a zero buffer. Opposed to using the padding located in the SRAM for log storage, a zero buffer will be used. A zero buffer or another storage location that is not the padding can be used for log storage to reduce the use of the SRAM. The data pointers will point the log copy to the new storage location. The use of the new location will result in more storage space in the SRAM.

In one embodiment, a data storage device comprises: a memory device; and a controller coupled to the memory device, wherein the controller is configured to: maintain a log to sync data in the memory device with mappings; detect a shutdown event; create a log copy of the log; and flush the log copy to the memory device, wherein the log copy includes log data and padding data, wherein the flushing comprises storing the log copy in the memory device and mapping the log data to a volatile memory device.

In another embodiment, a data storage device comprises: a memory device; and a controller coupled to the memory device, wherein the controller is configured to: read a log copy from the memory device, wherein the log copy includes log data and padding data; and store less than all data from the log copy in a volatile memory device. The storing comprises storing log data in the volatile memory device. Reading the log copy comprises reading pointers that point to volatile memory device memory locations. At least one pointer points to one flash memory unit (FMU) of log data. At least one pointer points to a zero buffer. The controller is configured to determine that an ungraceful shutdown (UGSD) event has occurred. The log copy is aligned to a page size of the memory device. The volatile memory device is static random access memory (SRAM).

In another embodiment, a data storage device comprises: means to store data; and a controller coupled to the first means to store data, wherein the controller is configured to: write a log copy to the first means to store data, wherein the log copy includes log data and padding data; retrieve the log copy from the first means to store data; and store less than all of the data from the log copy to a second means to store data, wherein the second means to store data is separate and distinct from the first means to store data.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 depicts a storage device with multiple SRAMs, according to certain embodiments.

FIG. 3 depicts log data using padding, according to certain embodiments.

FIG. 4 depicts log data without using padding, according to certain embodiments.

FIG. 5 is a flow chart illustrating a method for writing log data according to certain embodiments.

FIG. 6 is a flow chart illustrating a method for reading log data according to certain embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure generally relates to improved methods for reducing static random-access memory (SRAM) padding memory consumption. Rather than a data pointer pointing to the padding in the SRAM, the data pointer points to a zero buffer. Opposed to using the padding located in the SRAM for log storage, a zero buffer will be used. A zero buffer or another storage location that is not the padding can be used for log storage to reduce the use of the SRAM. The data pointers will point the log copy to the new storage location. The use of the new location will result in more storage space in the SRAM.

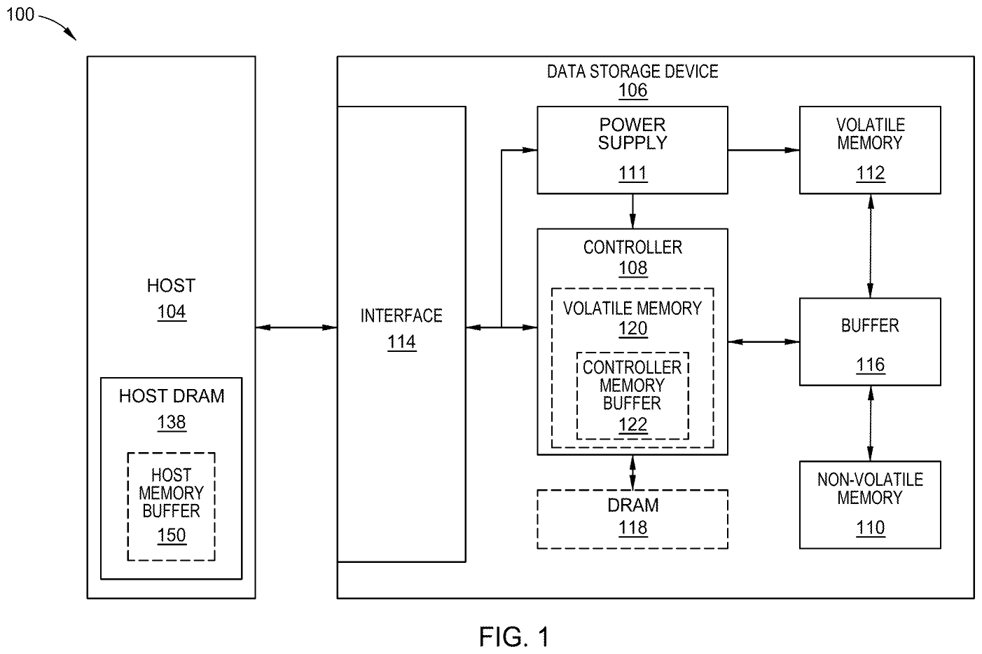

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

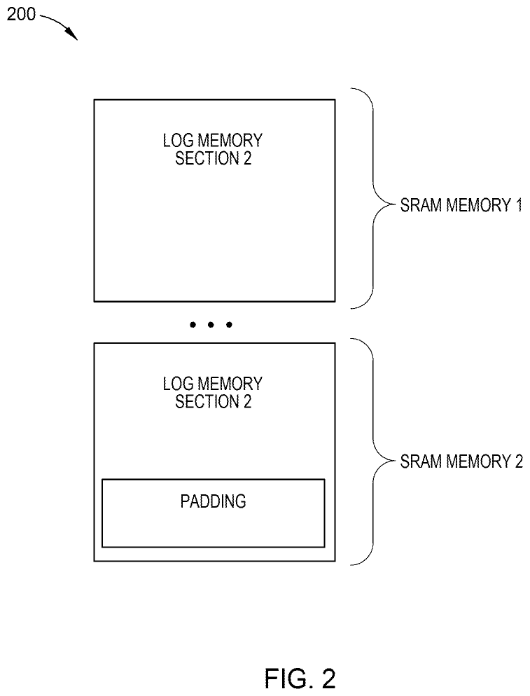

FIG. 2 depicts a storage device 200 with multiple SRAMs, according to certain embodiments. The storage device 200 comprises, but is not limited to, SRAM memory 1 and SRAM memory 2. SRAM memory 1 comprises log memory section 1 while SRAM memory 2 comprises log memory section 2 along with padding. The padding in SRAM memory 2 can be in the amount up to hundreds of kilobyte (KB) or more.

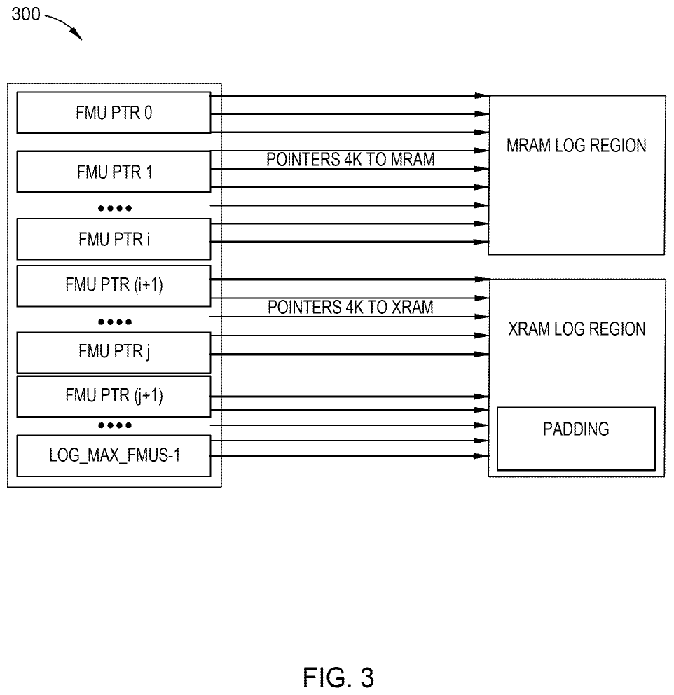

FIG. 3 depicts log data 300 using padding, according to certain embodiments. To allow effective read from the flash and write to the flash, there are sets of pointers to the SRAM Log location. The data pointers are initialized to point to the SRAM memories in flash memory units (FMU) (4 KB) resolution. The pointers are used to point to log contents and padding. Each data pointer points to 4K data. As an example, the log content size can be about 448 KB and the padding size can be about 64 KB. The log copy will be the total of both log contents size and the padding size. By padding data to achieve alignment to die page (64K) or alignment to alternative size, a significant amount of memory space is utilized for padding data and, correspondingly, flash data when the log copy is written to the memory device.

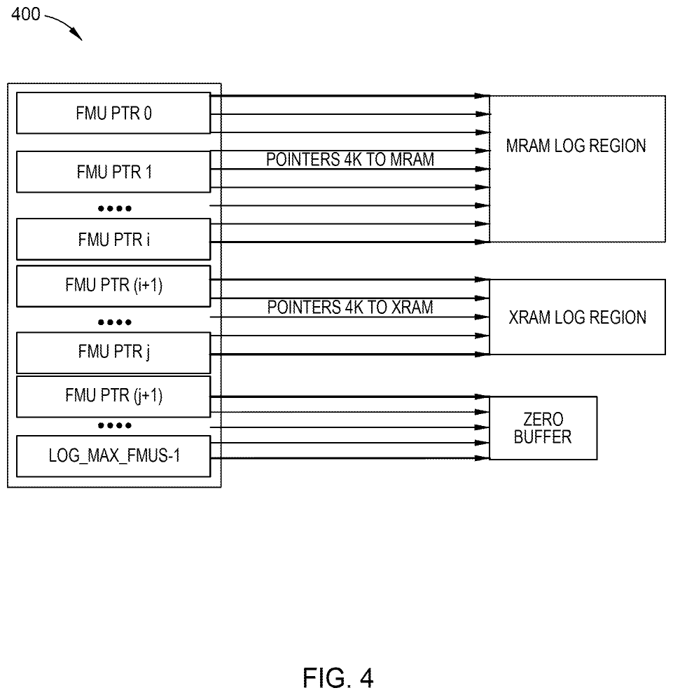

FIG. 4 depicts log data 400 without using padding, according to certain embodiments. Such an arrangement reduces log SRAM memory by reducing the padding as a reserved SRAM area for log data storage. Instead of the data pointers pointing to the padding in the SRAM memory, the data pointers will point to a zero buffer memory or another location for memory storage. The log copy size will remain the same size including the padding. By having the data pointers point to a zero buffer, the size of the padding will be saved in the SRAM when creating the log copy.

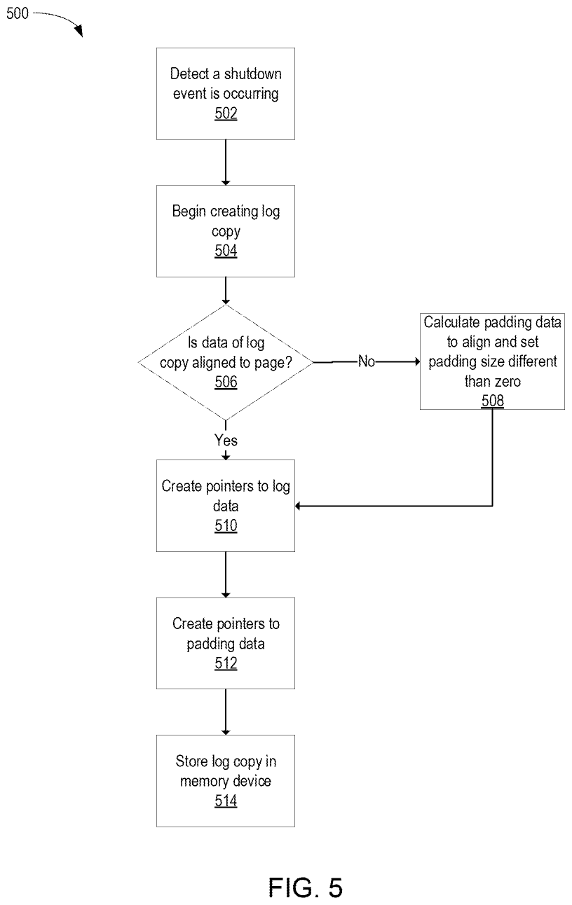

FIG. 5 is a flow chart illustrating a method 500 for writing log data according to certain embodiments. During the log write, the controller will store the log copy including the padding. The method 500 begins at block 502. At block 502, the controller, such as the controller 108 of FIG. 1, detects that a shutdown event is occurring. At block 504, the controller beings creating a log copy. At block 506, the controller determines whether the data of the log copy is aligned to a page. If the controller determines that the data of the log copy is aligned to the page, then the method 500 proceeds to block 510. If the controller determines that the data of the log copy is not aligned to the page, then the method 500 proceeds to block 508. At block 508, the controller calculates padding data to align and set padding size different than zero. At the completion of block 508 the method 500 proceeds to block 510. At block 510, the controller creates pointers to log data. At block 512, the controller creates pointers to padding data, which will be a zero buffer. At block 514, the controller stores the log copy in a memory device. The method 500 to write data to NAND with padding and read from NAND without padding can be used in other flows. Other flows include but not limited to XOR parity usage, which should be aligned to die pages using padding. For storing add padding to zero buffer and for loading padding is removed.

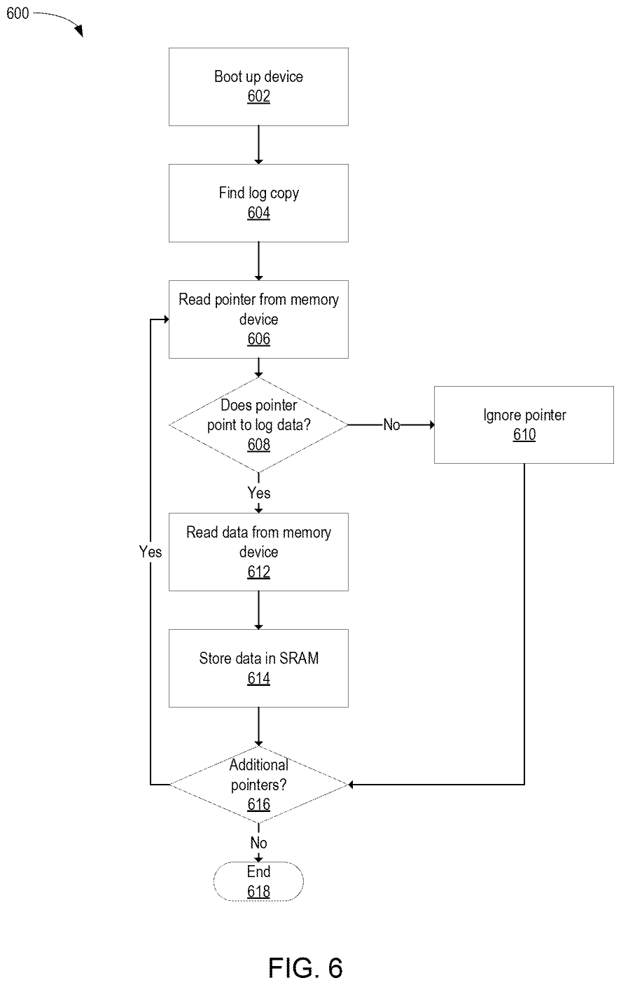

FIG. 6 is a flow chart illustrating a method 600 for reading log data according to certain embodiments. During log read, only content mapped to SRAM will need to be loaded from the flash because reading data from pointers which point to zero buffers for padding will be skipped. The method 600 begins at block 602. At block 602 the device boots up. At block 604, the controller, such as the controller 108, of FIG. 1 finds a log copy. At block 606, the controller reads a pointer from the memory device. At block 608, the controller determines whether the pointer points to log data. If the controller determines that the pointer does not point to the log data, then the method 600 proceeds to block 610. At block 610, the controller ignores the pointer and proceeds to block 616. If the controller determines that the pointer does point to the log data, then the method 600 proceeds to block 612. At block 612, the controller reads data from the memory device. At block 614, the controller stores data in the SRAM. At block 616, the controller determines whether there are any additional pointers. If the controller determines that there are additional pointers, then the method 600 returns to block 606. If the controller determines that there are not additional pointers then the method 600 proceeds to block 618 to end the method 600.

As discussed herein, data can be written to the memory device (e.g., NAND) with padding and then read from the memory device without padding. Such a procedure can be used in other processes such as XOR parity. XOR parity storage should be aligned to die pages using padding. The padding can be added to the zero buffer so that loading can occur without the padding.

By using a data pointer that points to a zero buffer or another storage location in the SRAM memory, the cost of using SRAM as storage for log copies is reduced. Additionally, the read process will be faster as padding data is not read from the memory device and the read disturb effect will be reduced. Performance will be improved during boot to load the log copy from the memory device. Additionally, SRAM size can be reduced which thus saves money.

In one embodiment, a data storage device comprises: a memory device; and a controller coupled to the memory device, wherein the controller is configured to: maintain a log to sync data in the memory device with mappings; detect a shutdown event; create a log copy of the log; and flush the log copy to the memory device, wherein the log copy includes log data and padding data, wherein the flushing comprises storing the log copy in the memory device and mapping the log data to a volatile memory device. The padding data is not mapped to the volatile memory device. The mapping comprises creating pointers to point the log data to log locations in the volatile memory device. Each pointer points to 4K of log data. The mapping comprises creating pointers to point the padding data to a zero buffer. The mapping comprises creating pointers to point the padding data to random non-padding data. The log copy is aligned to a die page of the memory device.

In another embodiment, a data storage device comprises: a memory device; and a controller coupled to the memory device, wherein the controller is configured to: read a log copy from the memory device, wherein the log copy includes log data and padding data; and store less than all data from the log copy in a volatile memory device. The storing comprises storing log data in the volatile memory device. Reading the log copy comprises reading pointers that point to volatile memory device memory locations. At least one pointer points to one flash memory unit (FMU) of log data. At least one pointer points to a zero buffer. The controller is configured to determine that an ungraceful shutdown (UGSD) event has occurred. The log copy is aligned to a page size of the memory device. The volatile memory device is static random access memory (SRAM).

In another embodiment, a data storage device comprises: means to store data; and a controller coupled to the first means to store data, wherein the controller is configured to: write a log copy to the first means to store data, wherein the log copy includes log data and padding data; retrieve the log copy from the first means to store data; and store less than all of the data from the log copy to a second means to store data, wherein the second means to store data is separate and distinct from the first means to store data. The writing comprises aligning the log data and padding data to a page size of the first means to store data. Writing comprises creating pointers to the log data and the padding data. Pointers for the padding data point to a zero buffer. The controller is configured to skip reading the padding data.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
maintain a log to sync data in the memory device with mappings;
detect a shutdown event;
create a log copy of the log; and
flush the log copy to the memory device, wherein the log copy includes log data and padding data, wherein the flushing comprises storing the log copy in the memory device and mapping the log data to a volatile memory device.

2. The data storage device of claim 1, wherein the padding data is not mapped to the volatile memory device.

3. The data storage device of claim 1, wherein the mapping comprises creating pointers to point the log data to log locations in the volatile memory device.

4. The data storage device of claim 3, wherein each pointer points to 4K of log data.

5. The data storage device of claim 1, wherein the mapping comprises creating pointers to point the padding data to a zero buffer.

6. The data storage device of claim 1, wherein the mapping comprises creating pointers to point the padding data to random non-padding data.

7. The data storage device of claim 1, wherein the log copy is aligned to a die page of the memory device.

8. A data storage device, comprising:
a memory device; and
a controller coupled to the memory device, wherein the controller is configured to:
read a log copy from the memory device, wherein the log copy includes log data and padding data; and
store less than all data from the log copy in a volatile memory device.

9. The data storage device of claim 8, wherein the storing comprises storing log data in the volatile memory device.

10. The data storage device of claim 8, wherein reading the log copy comprises reading pointers that point to volatile memory device memory locations.

11. The data storage device of claim 10, wherein at least one pointer points to one flash memory unit (FMU) of log data.

12. The data storage device of claim 10, wherein at least one pointer points to a zero buffer.

13. The data storage device of claim 8, wherein the controller is configured to determine that an ungraceful shutdown (UGSD) event has occurred.

14. The data storage device of claim 8, wherein the log copy is aligned to a page size of the memory device.

15. The data storage device of claim 8, wherein the volatile memory device is static random access memory (SRAM).

16. A data storage device, comprising:
a first means to store data; and
a controller coupled to the first means to store data, wherein the controller is configured to:
write a log copy to the first means to store data, wherein the log copy includes log data and padding data;
retrieve the log copy from the first means to store data; and
store less than all of the data from the log copy to a second means to store data, wherein the second means to store data is separate and distinct from the first means to store data.

17. The data storage device of claim 16, wherein the writing comprises aligning the log data and padding data to a page size of the first means to store data.

18. The data storage device of claim 16, wherein writing comprises creating pointers to the log data and the padding data.

19. The data storage device of claim 18, wherein pointers for the padding data point to a zero buffer.

20. The data storage device of claim 16, wherein the controller is configured to skip reading the padding data.
